(19) United States
(12) Patent Application Publication
(10) Pub. No.: US 2026/0106666 A1
(43) Pub. Date: Apr. 16, 2026

(54) OPTICAL FIBER PERFORMANCE DETECTION SYSTEM

(71) Applicant: Chunghwa Telecom Co., Ltd., Taoyuan City (TW)

(72) Inventors: Che-Hung Cho, Taoyuan City (TW); Bing-Xin Duan, Taoyuan City (TW); Ching-Po Lin, Taoyuan City (TW); Huei-Jen Chen, Taoyuan City (TW)

(73) Assignee: Chunghwa Telecom Co., Ltd., Taoyuan City (TW)

(21) Appl. No.: 18/959,553

(22) Filed: Nov. 25, 2024

(30) Foreign Application Priority Data
Oct. 14, 2024 (TW) 113139014

(51) Int. Cl. H04B 10/038; G01M 11/00

(52) U.S. Cl. CPC H04B 10/038; G01M 11/33

(57) ABSTRACT

Embodiments of the disclosure provide an optical fiber performance detection system, which includes a first optical fiber detection device and a second optical fiber detection device. The first optical fiber detection device is externally connected to a first position of a main optical fiber and provides a first optical signal with a first wavelength for transmission on the main optical fiber, wherein the first wavelength is different from a wavelength of a primary optical signal transmitted on the main optical fiber. The second optical fiber detection device is externally connected to a second position of the main optical fiber and detects the first optical signal transmitted on the main optical fiber. The second optical fiber detection device is configured to perform: in response to determining that the first optical signal transmitted on the main optical fiber is not detected, determining that the main optical fiber is malfunctioned.

### CROSS-REFERENCE TO RELATED APPLICATION

This application claims the priority benefit of Taiwan application serial no. 113139014, filed on October 14, 2024. The entirety of the above-mentioned patent application is hereby incorporated by reference herein and made a part of this specification.

### BACKGROUND

### TECHNICAL FIELD

The present invention relates to an optical fiber detection system, and particularly to an optical fiber performance detection system.

### DESCRIPTION OF RELATED ART

Traditional optical switches detect optical paths through reverse scattered light, but this approach not only requires consuming a portion (e.g., 5%) of the communication transmission signal power to detect the status of the optical path (e.g., unable to transmit signals due to dysfunctions), but may also lead to misjudgment of monitored data due to situations such as optical fiber connector plug detachment. In this situation, the optical path switching may not be executed due to incorrectly determining that the light intensity is sufficiently large.

### SUMMARY

In view of this, the disclosure provides an optical fiber performance detection system, which may be used to solve the above technical problems.

The embodiment of the disclosure provides an optical fiber performance detection system, including a first optical fiber detection device and a second optical fiber detection device. The first optical fiber detection device is externally connected to a first position of the main optical fiber, and provides a first optical signal having a first wavelength for transmission on the main optical fiber, wherein the first wavelength is different from the wavelength of a primary optical signal transmitted on the main optical fiber. The second optical fiber detection device is externally connected to a second position of the main optical fiber, and detects the first optical signal transmitted on the main optical fiber, wherein the second optical fiber detection device is configured to execute: in response to determining that the first optical signal transmitted on the main optical fiber is not detected, determining that the main optical fiber is malfunctioned.

### BRIEF DESCRIPTION OF THE DRAWINGS

FIG. 1 is a schematic diagram illustrating the optical fiber performance detection system according to the first embodiment of the disclosure.

FIG. 2 is a schematic diagram illustrating the optical fiber performance detection system depicted in FIG. 1.

FIG. 3 is a schematic diagram illustrating the optical fiber performance detection system according to the second embodiment of the disclosure.

FIG. 4 is a schematic diagram illustrating multiple network architectures managed by the network management center based on FIG. 3.

### DESCRIPTION OF THE EMBODIMENTS

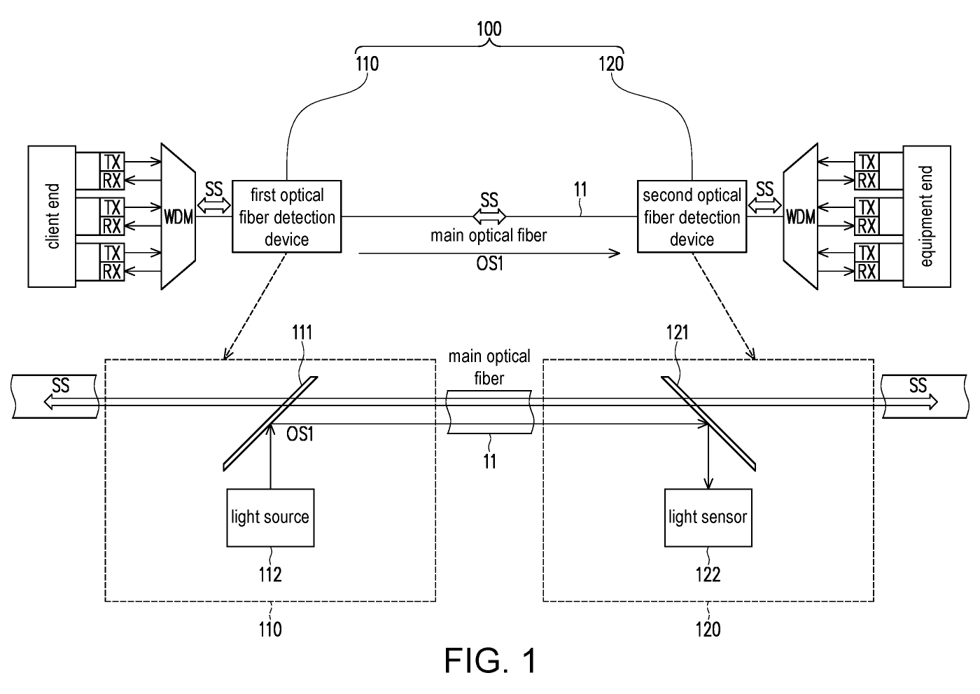

Please refer to FIG. 1, which is a schematic diagram illustrating the optical fiber performance detection system according to the first embodiment of the disclosure. In FIG. 1, the optical fiber performance detection system 100 includes a first optical fiber detection device 110 and a second optical fiber detection device 120.

In this embodiment, the first optical fiber detection device 110 is externally connected to a first position of the main optical fiber 11, and provides a first optical signal OS1 having a first wavelength for transmission on the main optical fiber 11, wherein the first wavelength is different from the wavelength of the primary optical signal SS transmitted on the main optical fiber 11.

In one embodiment, the first optical fiber detection device 110 includes a light source 112 and a beam splitter 111. The light source 112 transmits the first optical signal OS1 having the first wavelength. The beam splitter 111 is coupled to the light source 112 and the main optical fiber 11, and is used to guide the first optical signal OS1 transmitted by the light source 112 into the main optical fiber 11 for transmission.

In the embodiments of the disclosure, each light source mentioned below may be a component that can provide various optical signals, such as a laser light source (e.g., a laser diode) that can provide laser light, but the disclosure is not limited thereto. Furthermore, each light sensor mentioned below may be any sensing component that can detect optical signals, such as a detector that can detect the aforementioned laser light, but the disclosure is not limited thereto.

In the embodiments of the disclosure, the first optical fiber detection device 110 may have a built-in power supply (e.g., a battery) to provide the electrical power required for transmitting the first optical signal OS1. In other words, when the first optical fiber detection device 110 is externally connected to the first position of the main optical fiber 11, the first optical fiber detection device 110 may transmit the first optical signal OS1 without the need for external electrical power, but the disclosure is not limited thereto.

In FIG. 1, the second optical fiber detection device 120 is externally connected to a second position of the main optical fiber 11, and detects the first optical signal OS1 transmitted on the main optical fiber 11, wherein the second optical fiber detection device 120 is configured to perform: in response to determining that the first optical signal OS1 transmitted on the main optical fiber 11 is not detected, determining that the main optical fiber 11 is malfunctioned.

In one embodiment, the second optical fiber detection device 120 includes a beam splitter 121 and a light sensor 122. The beam splitter 121 is coupled to the main optical fiber 11, and is used to guide the first optical signal OS1 transmitted within the main optical fiber 11 to the light sensor 122. Additionally, the light sensor 122 is coupled to the beam splitter 121, and is used to sense the first optical signal OS1 guided by the beam splitter 121.

In the embodiments of the disclosure, the second optical fiber detection device 120 may have a built-in power supply (e.g., a battery) to provide the electrical power required for sensing the first optical signal OS1. In other words, when the second optical fiber detection device 120 is externally connected to the second position of the main optical fiber 11, the second optical fiber detection device 120 may sense the first optical signal OS1 without the need for external electrical power, but the disclosure is not limited thereto.

In different embodiments, the first position and the second position of the main optical fiber 11 may be any two positions on the main optical fiber 11, but the disclosure is not limited thereto.

In the embodiments of the disclosure, the primary optical signal SS may be, for example, an optical signal for substantial data exchange between the client end and the equipment end. Additionally, in some embodiments, the first optical signal OS1 may be a detection signal used solely for detecting the status of the main optical fiber 11, but the disclosure is not limited thereto.

In FIG. 1, one end of the first optical fiber detection device 110 may be connected to the main optical fiber 11, while the other end of the first optical fiber detection device 110 may be connected to a Wavelength Division Multiplexing (WDM) corresponding to the client end, but the disclosure is not limited thereto.

In this embodiment, the WDM corresponding to the client end may be connected to multiple transceivers belonging to the client end, wherein each set of transceivers is represented by a corresponding transmitter (denoted as TX) and receiver (denoted as RX), but the disclosure is not limited thereto.

Similarly, one end of the second optical fiber detection device 120 may be connected to the main optical fiber 11, while the other end of the second optical fiber detection device 120 may be connected to a WDM corresponding to the equipment end. In this situation, the WDM corresponding to the equipment end may be connected to multiple transceivers belonging to the equipment end, and these transceivers are also individually represented by corresponding TX and RX, but the disclosure is not limited thereto.

As shown in FIG. 1, the WDM corresponding to the client end and the WDM corresponding to the equipment end may transmit the primary optical signal SS through the main optical fiber 11. In this situation, the first optical fiber detection device 110 externally connected to the main optical fiber 11 may additionally send the first optical signal OS1 on the main optical fiber 11 towards the second optical fiber detection device 120 and/or the equipment end.

In one embodiment, if the main optical fiber 11 is properly functioning due to disconnection or other similar reasons, the first optical signal OS1 transmitted on the main optical fiber 11 may be successfully guided through the beam splitter 121 to the light sensor 122, and thereby be sensed by the light sensor 122.

In this situation, the second optical fiber detection device 120 may determine that the first optical signal OS1 transmitted on the main optical fiber 11 has been detected, and thereby determine that the main optical fiber 11 is properly functioning.

On the other hand, if the main optical fiber 11 is malfunctioned due to disconnection or other similar reasons, it will cause the first optical signal OS1 transmitted on the main optical fiber 11 to be unable to be successfully sensed by the light sensor 122.

In this situation, the second optical fiber detection device 120 may determine that the first optical signal OS1 transmitted on the main optical fiber 11 has not been detected, and thereby determine that the main optical fiber 11 is malfunctioned.

From the above, it can be seen that the embodiment of this disclosure may detect the status of the main optical fiber 11 (for example, whether the fiber segment between the first position and the second position on the main optical fiber 11 is malfunctioned) by connecting the first optical fiber detection device 110 and the second optical fiber detection device 120 at the first position and the second position of the main optical fiber 11, respectively, in an externally connected manner.

Based on this, compared to the traditional technique of detecting the status of the main optical fiber 11 based on a portion of the power of the primary optical signal SS, the means of the embodiments of the disclosure may perform non-invasive detection without affecting the transmission status of the original primary optical signal SS. Moreover, since the first optical fiber detection device 110 and the second optical fiber detection device 120 may use built-in power supplies to transmit and detect optical signals, the concept of this disclosure can be realized without the need for fixed power supplies. Thereby, the technical solution of the embodiments of the disclosure can not only solve the problem of data misjudgment due to the detachment of optical fiber connector plugs, but also simultaneously solve the problems of high cost and difficult maintenance caused by the need to build optical switching machines into equipment in existing systems.

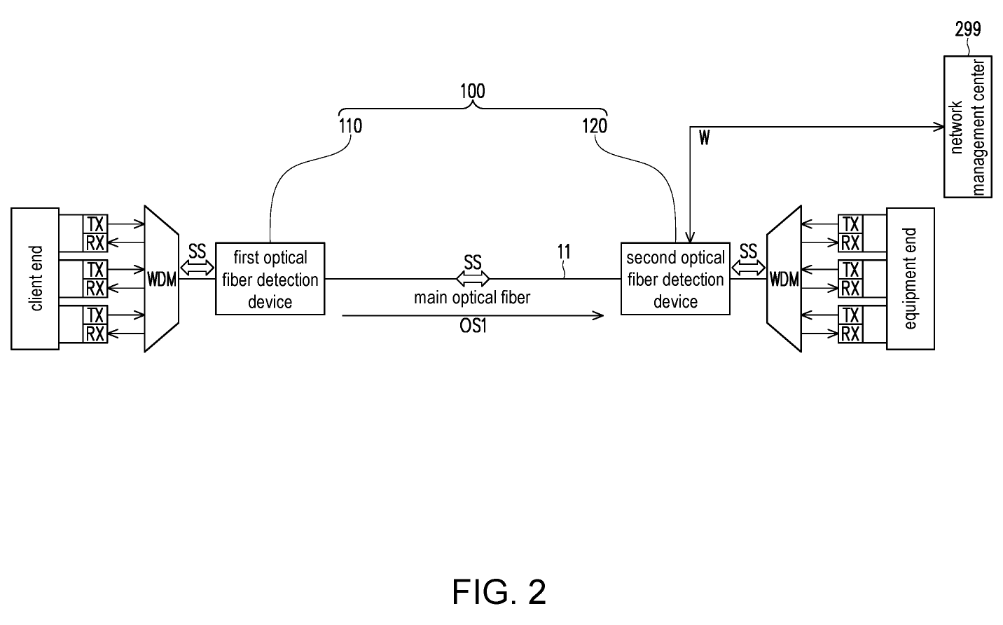

Please refer to FIG. 2, which is a schematic diagram illustrating the optical fiber performance detection system based on FIG. 1. In FIG. 2, the structure and operation method of the optical fiber performance detection system 100 can generally be referred to in the relevant description of FIG. 1, and will not be repeated here.

Unlike FIG. 1, the second optical fiber detection device 120 in FIG. 2 may provide a warning W to the network management center 299 when it determines that the main optical fiber 11 is malfunctioned. Thereby, it allows the personnel at the network management center 299 to grasp the status of the main optical fiber 11 in real-time and take corresponding handling measures (for example, dispatching personnel for maintenance, etc.), but the disclosure is not limited thereto.

In the first embodiment shown in FIG. 1 and FIG. 2, the concept can be understood as the first optical fiber detection device 110 unidirectionally transmitting the first optical signal OS1 to the second optical fiber detection device 120, so that the second optical fiber detection device 120 can determine the status of the main optical fiber 11 based on whether it senses the first optical signal OS1.

In other embodiments, the second optical fiber detection device may also transmit a second optical signal to the first optical fiber detection device, so that the first optical fiber detection device can determine the status of the main optical fiber based on whether it senses the second optical signal. Moreover, when a backup optical fiber exists between the client end and the equipment end, the first optical fiber detection device and the second optical fiber detection device may immediately switch to using the backup optical fiber to transmit the primary optical signal when they individually detect that the main optical fiber is malfunctioned. Thereby, it may avoid affecting the communication between the client end and the equipment end due to the malfunctioned main optical fiber. The following will provide further explanation with a second embodiment.

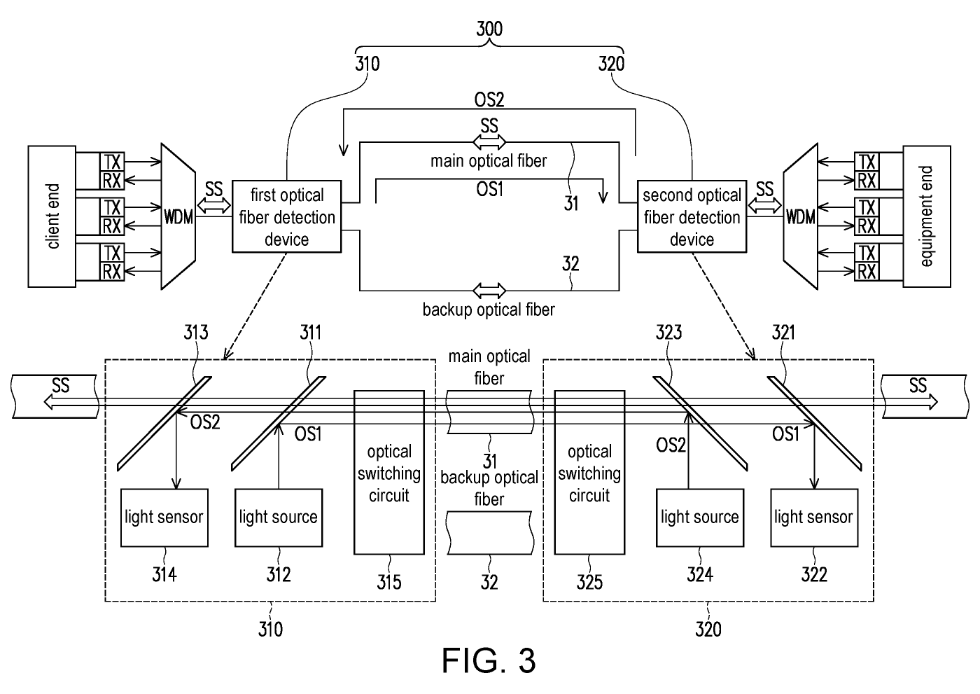

Please refer to FIG. 3, which is a schematic diagram illustrating the optical fiber performance detection system according to the second embodiment of this disclosure.

In FIG. 3, the optical fiber performance detection system 300 includes a first optical fiber detection device 310 and a second optical fiber detection device 320.

The first optical fiber detection device 310 is externally connected to a first position of the main optical fiber 31, and provides a first optical signal OS1 having a first wavelength for transmission on the main optical fiber 31, wherein the first wavelength is different from the wavelength of a primary optical signal SS transmitted on the main optical fiber 31.

The second optical fiber detection device 320 is externally connected to a second position of the main optical fiber 31, and detects the first optical signal OS1 transmitted on the main optical fiber 31, wherein the second optical fiber detection device 320 is configured to perform: in response to determining that the first optical signal OS1 transmitted on the main optical fiber 31 is not detected, determining that the main optical fiber 31 is malfunctioned.

In this embodiment, the method by which the first optical fiber detection device 310 and the second optical fiber detection device 320 perform the aforementioned operations may refer to the relevant explanations of FIG. 1. Additionally, the devices and structures corresponding to the client end and equipment end may also refer to the relevant explanations of FIG. 1.

Unlike FIG. 1, in FIG. 3, the first optical fiber detection device 310 is further externally connected to a first position of the backup optical fiber 32, and the second optical fiber detection device 320 is further externally connected to a second position of the backup optical fiber 32, wherein the first position and the second position of the backup optical fiber 32 are, for example, any two positions on the backup optical fiber 32, but the disclosure is not limited thereto.

Moreover, the second optical fiber detection device 320 is further configured to provide a second optical signal OS2 having a second wavelength for transmission on the main optical fiber 31, wherein the second wavelength is different from the first wavelength and the wavelength of the primary optical signal SS.

In some embodiments, the first optical signal OS1 and the second optical signal OS2 may respectively be two different detection signals used solely for detecting the status of the main optical fiber 11, but the disclosure is not limited thereto.

In this situation, the first optical fiber detection device 310 may further detect the second optical signal OS2 transmitted on the main optical fiber 31, and is configured to perform: in response to determining that the second optical signal OS2 transmitted on the main optical fiber 31 is not detected, determining that the main optical fiber 31 is malfunctioned, and switching to use the backup optical fiber 32 to transceive the primary optical signal SS. Moreover, in response to the second optical fiber detection device 320 determining that the main optical fiber 31 is malfunctioned, the second optical fiber detection device 320 switches to use the backup optical fiber 32 to transceive the primary optical signal SS.

In other words, the first optical fiber detection device 310 and the second optical fiber detection device 320 may respectively transmit the first optical signal OS1 and the second optical signal OS2 to each other through the main optical fiber 31. Moreover, the first optical fiber detection device 310 and the second optical fiber detection device 320 may respectively detect whether the second optical signal OS2 and the first optical signal OS1 transmitted by the other party are detected on the main optical fiber 31.

In one embodiment, if the main optical fiber 31 has not experienced a fault (for example, the segment between the first position and the second position on the main optical fiber 31 is not disconnected), the first optical fiber detection device 310 may detect the second optical signal OS2 transmitted by the second optical fiber detection device 320 on the main optical fiber 31, and the second optical fiber detection device 320 may detect the first optical signal OS1 transmitted by the first optical fiber detection device 310 on the main optical fiber 31. In this situation, the first optical fiber detection device 310 and the second optical fiber detection device 320 may respectively determine that the main optical fiber 31 has not experienced a fault.

On the other hand, if the main optical fiber 31 experiences a fault (for example, the segment between the first position and the second position on the main optical fiber 31 is disconnected), the first optical fiber detection device 310 will be unable to detect the second optical signal OS2 transmitted by the second optical fiber detection device 320 on the main optical fiber 31, and the second optical fiber detection device 320 will also be unable to detect the first optical signal OS1 transmitted by the first optical fiber detection device 310 on the main optical fiber 31. In this situation, the first optical fiber detection device 310 and the second optical fiber detection device 320 may respectively determine that the main optical fiber 31 is malfunctioned.

In FIG. 3, since the first optical fiber detection device 310 and the second optical fiber detection device 320 are also connected to the first position and the second position of the backup optical fiber 32 respectively, when the first optical fiber detection device 310 and the second optical fiber detection device 320 determine that the main optical fiber 31 is malfunctioned, the first optical fiber detection device 310 and the second optical fiber detection device 320 may immediately switch to use the backup optical fiber 32 to transmit the primary optical signal SS, thereby maintaining communication between the client end and the equipment end.

In one embodiment, the first optical fiber detection device 310 includes a first light source 312, a first beam splitter 311, a second beam splitter 313, a first light sensor 314, and a first optical switching circuit 315. The first light source 312 transmits the first optical signal OS1 having a first wavelength. The first beam splitter 311 is coupled to the first light source 312 and the main optical fiber 31, and is used to guide the first optical signal OS1 transmitted by the first light source 312 into the main optical fiber 31 for transmission. The second beam splitter 313 is coupled to the main optical fiber 31 and is used to guide the second optical signal OS2 transmitted within the main optical fiber 31 to the first light sensor 314. The first light sensor 314 is coupled to the second beam splitter 313 and is used to sense the second optical signal OS2 guided by the second beam splitter 313. The first optical switching circuit 315 is coupled to the first position of the main optical fiber 31 and the first position of the backup optical fiber 32, and is used to switch between using the main optical fiber 31 or the backup optical fiber 32 to transceive the primary optical signal SS.

In one embodiment, the first optical switching circuit 315 is, for example, an optical switch that is simultaneously coupled to the main optical fiber 31 and the backup optical fiber 32 and may perform optical path switching.

In an embodiment of the disclosure, when the main optical fiber 31 is properly functioning, the first optical switching circuit 315 may allow the primary optical signal SS to be transmitted through the main optical fiber 31 to the second optical fiber detection device 320 and/or the equipment end. On the other hand, when the main optical fiber 31 is malfunctioned, the first optical switching circuit 315 may switch to use the backup optical fiber 32, thereby allowing the primary optical signal SS to be transmitted through the backup optical fiber 32 to the second optical fiber detection device 320 and/or the equipment end, but the disclosure is not limited thereto.

In an embodiment of the disclosure, the second optical fiber detection device 310 may have a built-in power supply (e.g., a battery) to provide the electrical power required for transmitting the first optical signal OS1 and detecting the second optical signal OS2. In other words, when the first optical fiber detection device 310 is externally connected to the first position of the main optical fiber 31, the first optical fiber detection device 310 may transmit the first optical signal OS1 and detect the second optical signal OS2 without the need for external electrical power, but the disclosure is not limited thereto.

Additionally, the second optical fiber detection device 320 includes a second light source 324, a third beam splitter 323, a fourth beam splitter 321, a second light sensor 322, and a second optical switching circuit 325. The second light source 324 transmits a second optical signal OS2 having a second wavelength. The third beam splitter 323 is coupled to the second light source 324 and the main optical fiber 31, and is used to guide the second optical signal OS2 transmitted by the second light source 324 into the main optical fiber 31 for transmission. The fourth beam splitter 321 is coupled to the main optical fiber 31 and is used to guide the first optical signal OS1 transmitted in the main optical fiber 31 to a second light sensor 322. The second light sensor 322, coupled to the fourth beam splitter 321, is used to sense the first optical signal OS1 guided by the fourth beam splitter 321. The second optical switching circuit 325 is coupled to the second position of the main optical fiber 31 and the second position of the backup optical fiber 32, and is used to switch between using the main optical fiber 31 or the backup optical fiber 32 to transceive the primary optical signal SS.

In one embodiment, the second optical switching circuit 325 is, for example, an optical switch that is simultaneously coupled to the main optical fiber 31 and the backup optical fiber 32 and may perform optical path switching.

In an embodiment of the disclosure, when the main optical fiber 31 is properly functioning, the second optical switching circuit 325 may allow the primary optical signal SS to be transmitted through the main optical fiber 31 to the first optical fiber detection device 310 and/or the client end. On the other hand, when the main optical fiber 31 is malfunctioned, the second optical switching circuit 325 may switch to use the backup optical fiber 32, thereby allowing the primary optical signal SS to be transmitted through the backup optical fiber 32 to the first optical fiber detection device 310 and/or the client end, but the disclosure is not limited thereto.

In an embodiment of the disclosure, the second optical fiber detection device 320 may have a built-in power supply (e.g., a battery) to provide the electrical power required for transmitting the second optical signal OS2 and sensing the first optical signal OS1. In other words, when the second optical fiber detection device 320 is externally connected to the second position of the main optical fiber 31, the second optical fiber detection device 320 may transmit the second optical signal OS2 and sense the first optical signal OS1 without the need for external electrical power, but the disclosure is not limited thereto.

Moreover, similar to the concept described in FIG. 2, the first optical fiber detection device 310 and/or the second optical fiber detection device 320 in FIG. 3 may also provide a warning to the network management center when it is determined that the main optical fiber 31 is malfunctioned. Thereby, the personnel at the network management center may immediately grasp the status of the main optical fiber 31 and take corresponding handling means (e.g., dispatching personnel for maintenance, etc.), but the disclosure is not limited thereto.

In some embodiments, if the overall architecture shown in FIG. 3 is viewed as a network architecture, the aforementioned network management center may simultaneously manage multiple network architectures. In this situation, the personnel at the network management center may immediately grasp the status of the main optical fibers in each network architecture based on the warnings provided by each network architecture, and thereby take corresponding handling means (e.g., dispatching personnel for maintenance, etc.), but the disclosure is not limited thereto.

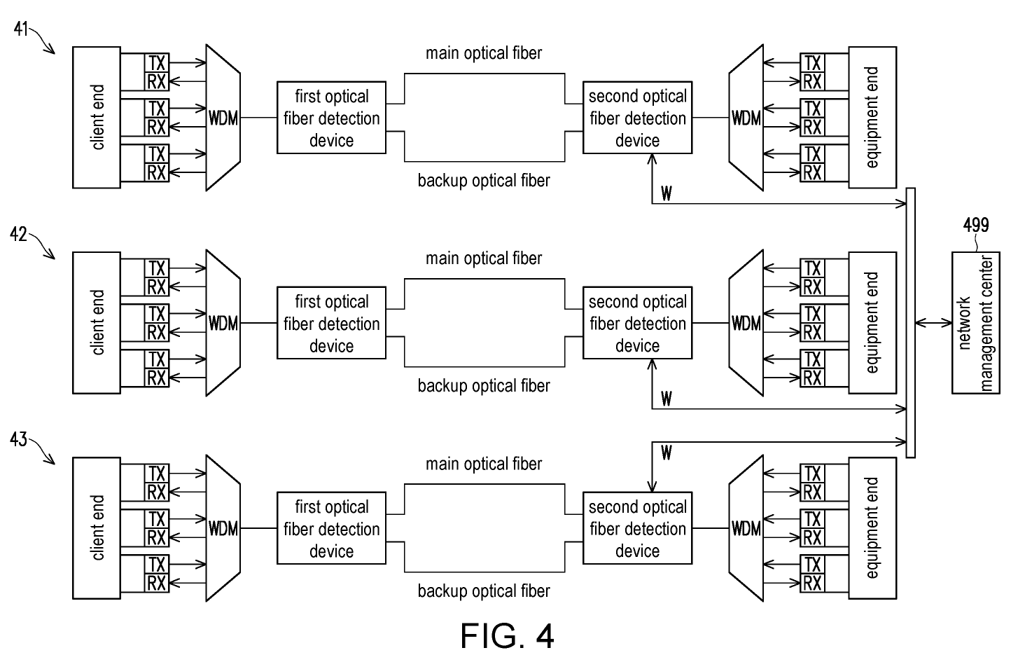

Please refer to FIG. 4, which illustrates a diagram of multiple network architectures managed by the network management center based on FIG. 3.

In FIG. 4, the illustrated network may include multiple network architectures 41 to 43 as shown in FIG. 3, and the network architectures 41 to 43 (specifically, their second optical fiber detection devices) may be individually connected to the network management center 499. In this situation, each network architecture 41 to 43 may operate according to the methods taught in the previous embodiments, and may send corresponding warnings W to the network management center 499 in a timely manner based on the status of their corresponding main optical fibers (e.g., whether they are malfunctioned or not), but the disclosure is not limited thereto.

In summary, the optical fiber performance detection system provided by the embodiments of the disclosure may detect the status of the main optical fiber (e.g., whether the fiber segment between the first position and the second position on the main optical fiber is malfunctioned) by connecting the first optical fiber detection device and the second optical fiber detection device at the first position and the second position of the main optical fiber, respectively, through external connection methods.

Based on this, the means of the disclosure's embodiments may perform non-intrusive detection without affecting the transmission status of the original primary optical signal. Moreover, since the first optical fiber detection device and the second optical fiber detection device may use built-in power supplies to transmit and detect optical signals, the concept of this disclosure can be realized without the need for fixed power supply points.

Furthermore, in situations where a backup optical fiber exists, the first optical fiber detection device and the second optical fiber detection device of the disclosure's embodiments may also immediately switch to using the backup optical fiber to transmit the primary optical signal when a fault in the main optical fiber is detected. Thereby, the communication between the client end and the equipment end may be better maintained.

From the above, it can be seen that the technical solution of the disclosure's embodiments may not only solve the problem of data misjudgment due to the detachment of optical fiber connector plugs, but also simultaneously solve the problems of high cost and difficult maintenance caused by the need to build optical switching machines into equipment in existing systems.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical fiber performance detection system, comprising:
a first optical fiber detection device, externally coupled to a first position of a main optical fiber, and providing a first optical signal having a first wavelength for transmission on the main optical fiber, wherein the first wavelength is different from a wavelength of a primary optical signal transmitted on the main optical fiber;
a second optical fiber detection device, externally coupled to a second position of the main optical fiber, and detecting the first optical signal transmitted on the main optical fiber, wherein the second optical fiber detection device is configured to execute:
in response to determining that the first optical signal transmitted on the main optical fiber is not detected, determining that the main optical fiber is malfunctioned.

2. The optical fiber performance detection system as claimed in claim 1, wherein the first optical fiber detection device comprises:
a first light source, transmitting the first optical signal having the first wavelength; and
a first beam splitter, coupled to the first light source and the main optical fiber, and used to guide the first optical signal transmitted by the first light source for transmission within the main optical fiber.

3. The optical fiber performance detection system as claimed in claim 2, wherein the second optical fiber detection device comprises:
a second beam splitter, coupled to the main optical fiber, and used to guide the first optical signal transmitted within the main optical fiber to a first light sensor; and
the first light sensor, coupled to the second beam splitter, and used to sense the first optical signal guided by the second beam splitter.

4. The optical fiber performance detection system as claimed in claim 1, wherein the second optical fiber detection device is further configured to execute:
in response to determining that the main optical fiber is malfunctioned, providing a warning to a network management center.

5. The optical fiber performance detection system as claimed in claim 1, wherein the first optical fiber detection device is further externally coupled to a first position of a backup optical fiber, and the second optical fiber detection device is further externally coupled to a second position of the backup optical fiber,
wherein, the second optical fiber detection device is further configured to provide a second optical signal having a second wavelength for transmission on the main optical fiber, wherein the second wavelength is different from the first wavelength and the wavelength of the primary optical signal;
wherein the first optical fiber detection device further detects the second optical signal transmitted on the main optical fiber, and is configured to execute:
in response to determining that the second optical signal transmitted on the main optical fiber is not detected, determining that the main optical fiber is malfunctioned, and switching to use the backup optical fiber to transceive the primary optical signal;
wherein in response to the second optical fiber detection device determining that the main optical fiber is malfunctioned, the second optical fiber detection device switches to use the backup optical fiber to transceive the primary optical signal.

6. The optical fiber performance detection system as claimed in claim 4, wherein the first optical fiber detection device comprises:
a first light source, transmitting the first optical signal having the first wavelength;
a first beam splitter, coupled to the first light source and the main optical fiber, and used to guide the first optical signal transmitted by the first light source for transmission within the main optical fiber;
a second beam splitter, coupled to the main optical fiber, and used to guide the second optical signal transmitted within the main optical fiber to a first light sensor;
the first light sensor, coupled to the second beam splitter, and used to sense the second optical signal guided by the second beam splitter; and
a first optical switching circuit, coupled to the first position of the main optical fiber and the first position of the backup optical fiber, and used for switching to use either the main optical fiber or the backup optical fiber to transceive the primary optical signal.

7. The optical fiber performance detection system as claimed in claim 5, wherein the second optical fiber detection device comprises:
a second light source, transmitting the second optical signal having the second wavelength;
a third beam splitter, coupled to the second light source and the main optical fiber, and used to guide the second optical signal transmitted by the second light source for transmission within the main optical fiber;
a fourth beam splitter, coupled to the main optical fiber, and used to guide the first optical signal transmitted within the main optical fiber to a second light sensor;
the second light sensor, coupled to the fourth beam splitter, and used to sense the first optical signal guided by the fourth beam splitter; and
a second optical switching circuit, coupled to the second position of the main optical fiber and the second position of the backup optical fiber, and used for switching to use either the main optical fiber or the backup optical fiber to transceive the primary optical signal.
